(19) United States
(12) Patent Application Publication
(10) Pub. No.: US 2024/0101078 A1
(43) Pub. Date: Mar. 28, 2024

(54) INTERFACE DEVICE FOR A COMPONENT OF A VEHICLE BRAKE SYSTEM

(71) Applicant: Robert Bosch GmbH, Stuttgart (DE)

(72) Inventors: Andreas Weh, Sulzberg (DE); Johji Naka, Kempten (DE)

(21) Appl. No.: 18/448,420

(22) Filed: Aug. 11, 2023

(30) Foreign Application Priority Data
Sep. 28, 2022 (DE) 10 2022 210 233.9

(51) Int. Cl. B60T 7/04

(52) U.S. Cl. CPC B60T 7/042; B60T 2220/04

(57) ABSTRACT

An interface device for a component of a functional system of a vehicle brake system for fastening a pedal-travel sensor coupled to the component and for fastening the component on an associated vehicle. The interface device has a first contact surface to be positioned on the component and has a second contact surface to be positioned on the vehicle. The second contact surface is set at an oblique angle with respect to the first contact surface.

### CROSS REFERENCE

The present application claims the benefit under 35 U.S.C. § 119 of German Patent Application No. DE 10 2022 210 233.9 filed on Sep. 28, 2022, which is expressly incorporated herein by reference in its entirety.

### FIELD

The present invention relates to an interface device for a component of a functional system of a vehicle brake system for fastening a pedal-travel sensor coupled to the component and for fastening the component on an associated vehicle, the interface device being designed having a first contact surface to be positioned on the component and having a second contact surface to be positioned on the vehicle. The present invention further relates to a functional system of a vehicle brake system having a component and such an interface device.

### BACKGROUND INFORMATION

Vehicle brake systems of motor vehicles comprise one or multiple functional systems, by which controlled brake pressures are provided in associated brake systems. A controlled brake pressure is required especially in vehicle control systems, such as an anti-lock system (ABS), an anti-slip regulation (ASR) and/or an electronic stability program (ESP). For this purpose, a hydraulic unit is provided as the functional system, which in a hydraulic housing as the component comprises various hydraulic elements, such as valves, sensors, hydraulic accumulators, damping chambers and normally motor-driven pressure devices, such as a plunger or power cylinder.

A power piston produces brake pressure by way of the plunger. The plunger is controlled by a pedal-travel sensor, which is operated by driver of the motor vehicle or vehicle using a pedal. The pedal-travel sensor is normally coupled to the hydraulic housing in fixed and force-transmitting fashion via an adapter and an interface plate. By way of the interface plate as an interface device, the hydraulic housing and thus the hydraulic unit as a whole is fastened on the associated vehicle, in particular on a bulkhead of the vehicle. The hydraulic unit is located in an engine compartment of the vehicle.

It is conventional to situate a brake booster coupled to the pedal-travel sensor as a functional system in the engine compartment between the hydraulic unit and the vehicle. For this purpose, the brake booster normally has a booster housing as a component, on which the interface device is situated.

Depending on the type of vehicle, different engine compartments of different sizes exist, in which different functional systems and/or further components are accommodated. Different pedal-travel sensors are also used depending on the type of vehicle brake system. This makes it necessary to ensure that different pedal-travel sensors are reliably held on the component, such as on the hydraulic housing or the booster housing, and that the functional system, such as the hydraulic unit or the brake booster, is appropriately integrated into the respective vehicle brake system in the engine compartment of the vehicle. Such different pedal-travel sensors and engine compartments thus require different, cost-effective and operationally reliable mounts that are at the same time easy to install.

### SUMMARY

According to the present invention, an interface device is created for a component of a functional system of a vehicle brake system for fastening a pedal-travel sensor coupled to the component and for fastening the component on an associated vehicle. The interface device is designed having a first contact surface to be positioned on the component and having a second contact surface to be positioned on the vehicle. Furthermore, the second contact surface is set at an oblique angle with respect to the first contact surface.

The present invention is additionally also directed to a use of such an interface device on or in a functional system of a vehicle brake system. Accordingly, the present invention is further directed to a functional system of a vehicle brake system including a component and a pedal-travel sensor coupled to it as well as an interface device for fastening the pedal-travel sensor on the component and for fastening the component on an associated vehicle. The interface device is designed having a first contact surface positioned on the component and having a second contact surface to be positioned on the vehicle. Furthermore, the second contact surface is set obliquely with respect to the first contact surface.

The obliquely angled position, according to the present invention, of the first contact surface with respect to the second contact surface creates an angled interface device, which is designed in an angled manner with respect to the first contact surface or the surface of contact to the functional system. Such an angled design creates a mount that facilitates fastening the component and thus the functional system as a whole on the vehicle. In addition, an installation situation in a space available in the vehicle is improved considerably. In particular, more space is provided for a brake fluid reservoir situated on the component. Furthermore, for the purpose of venting the vehicle brake system necessary in reconditioning, the functional system is more readily accessible in a state in which it is fastened on the vehicle.

The interface device according to the present invention is suitable for all functional systems or brake systems that are to be mounted on a bulkhead of the vehicle.

According to the present invention, the functional system is preferably a hydraulic unit and the associated component is a hydraulic housing, on which the hydraulic unit is to be fastened on the vehicle by way of the interface device. Such an hydraulic housing is preferably a component of a vacuum-independent, electrohydraulic functional system, which comprises brake-boosting and ESP functionality, such as particularly preferably an integrated power brake (IBP) brake system.

Further preferred according to the present invention, the functional system is a brake booster and the associated component is in particular a booster housing, on which the brake booster is to be fastened on the vehicle by way of the interface device. Such a functional system is particularly preferably a vacuum-independent, in particular electromechanical brake booster, preferably a so-called iBooster.

The mentioned advantages are achieved by the spatial conditions in an engine compartment of the vehicle and the spatial conditions at the component designed in accordance with the present invention.

According to an example embodiment of the present invention, the hydraulic housing as the preferable component has in particular a block-shaped design and has two broad sides opposite each other, which border four narrow sides. A control unit is situated on one of the broad sides, which is designated as the control unit side. On the opposite broad side, which is designated the motor side, a motor associated with the hydraulic unit is situated, the motor shaft of which protrudes into a motor receptacle of the hydraulic housing. The motor shaft has a shaft axis that extends along or in parallel to an imaginary Y axis of a right-handed Cartesian coordinate system. The Y axis is oriented away from the motor side in its Y direction. Defined in this way, the pedal-travel sensor extends with its longitudinal orientation in the direction of an X axis, the pedal-travel sensor being situated on a narrow side of the hydraulic housing designated as the pedal side. Adjoining the pedal side is a narrow side referred to as the reservoir side, on which the brake fluid reservoir is situated. The Z axis of the coordinate system extends in the direction of the reservoir side between the reservoir side and its opposite narrow side.

According to an example embodiment of the present invention, the booster housing of the brake booster as the further preferable component has an in particular cup-shaped design. The booster housing has a cup bottom, a cylindrical cup wall and an open area opposite the cup bottom. The pedal-travel sensor extends into this open area with its pedal rod or longitudinal extension, which is coupled through an opening in the cup bottom to a piston in particular of a master brake cylinder. The longitudinal extension of the pedal-travel sensor thus defines the X direction of the coordinate system, along which the X axis points in the direction of the cup bottom. In the Z direction, a brake fluid reservoir is situated on the cup-shaped housing. In an installation situation on the vehicle, the associated Z axis points into an upper area. According to a right-handed Cartesian coordinate system, the associated Y axis extends perpendicularly from the axes thus defined. Furthermore, in a flange plane parallel to the Y axis, a flange protruding radially from the cup wall is provided at the open area, which thus represents a pedal side. The first contact surface of the interface device is to be positioned on the flange or is so positioned in the functional system.

The interface device according to the present invention is thus to be situated with its first contact surface respectively on the pedal side of the component and with its second contact surface set at an oblique angle with respect to the first contact surface is to be situated on the vehicle, in particular on a bulkhead provided there, which borders the engine compartment. The second contact surface set at an oblique angle with respect to the first contact surface produces an arrangement of the component, in particular of the hydraulic housing or the booster housing, and thus of the functional system, in particular of the hydraulic unit or the brake booster, as a whole, that is rotated about the Y axis. Rotated in this manner, more space is provided for the brake fluid reservoir in relation to further bounding elements in the vehicle, particularly in a vertical direction about the Z axis. A gain in height is thus achieved in particular for the brake fluid reservoir. Moreover, the rotated arrangement in the installed state on the vehicle produces additional room, which ensures a subsequent venting in particular of the hydraulic unit. Particularly in the case of a vertical bulkhead, the hydraulic housing angularly arranged by way of the interface device according to the present invention provides sufficient space for venting.

According to an example embodiment of the present invention, the second contact surface is set obliquely at an angle of 1° to 44°, preferably of 5° to 30°, particularly preferably of 8° to 25° and very particularly preferably of 10° to 15° with respect to the first contact surface. It has been shown that at such an angle the attachment of the functional system may be adapted to the respective installation situation at the vehicle in a particular flexible and accurately fitting manner. Particularly at the preferred angle of 5° to 30°, a flexible inclination is achieved about the mentioned Y axis of the functional system, preferably of the hydraulic unit or the brake booster, while at the same time achieving a sufficiently space saving spatial requirement for a required angular section at the interface device.

For this purpose, in the functional system according to the present invention, the pedal-travel sensor in its longitudinal extension preferably defines the X axis of a right-handed Cartesian coordinate system, the X direction of which points from pedal-travel sensor located outside of the component in the direction of the component. The associated Y axis extends at a right angle with respect to this X axis. In a rotation about the Y axis, a positive angle of rotation applies to all rotations that transfer the positive Z axis on the shortest path in the direction of the positive X axis. For this purpose, the second contact surface of the interface device is advantageously set at an oblique angle with respect to the first contact surface in such a way that a rotation about the Y axis at an angle of rotation of +5° to −44° including a tolerance of in particular +/−5°, preferably of nominally 0° to −30° and particularly preferably of nominally −8° to −25° is achieved.

To this end, advantageously, several types of interface devices are created, each having a different angle within the mentioned range. Depending on the installation situation, the respective type of interface device with the suitable angle is then selected for assembly.

According to an example embodiment of the present invention, particularly advantageously, the second contact surface is set at an oblique angle with respect to the first contact surface, the angle being changeable or adaptable. Thus it is possible to set a suitable angle between the first and the second contact surfaces only upon assembly as a function of the installation situation, which depends on the type of vehicle and/or the type of vehicle brake system, and depending on the space required for the brake fluid reservoir. By way of such an adaptable angle, with only one type of interface device to be produced, the associated functional system can be installed in the vehicle in a flexible and accurately fitting manner.

According to an example embodiment of the present invention, the first contact surface and/or the second contact surface are designed to be plate-shaped, in particular designed as a plate. This creates a particularly space saving interface device that is simple to manufacture. In addition, the first contact surface is advantageously designed to be essentially plane, thus forming a first contact plane. Furthermore, the second contact surface is advantageously designed to be essentially plane, thus forming a second contact plane. This makes it possible for forces acting on the two contact planes to be transmitted particularly well in a force-transmitting planar manner onto respectively adjoining components, such as the hydraulic housing or the booster housing and the vehicle bulkhead.

Furthermore, according to an example embodiment of the present invention, the first contact surface and/or the second contact surface are advantageously designed as deep-drawn parts, which are preferably metallic. In deep drawing, a hollow body is formed by tensile-compressive forming, which is open on one side and which has the first and/or the second contact surface. This results in lateral surfaces extending at right angles to the respective contact surface, which act in a stabilizing manner on the first and/or the second contact surface. Moreover, deep drawing may be performed in a particular simple and cost-effective manner.

Furthermore, according to an example embodiment of the present invention, the first contact surface and the second contact surface are advantageously designed together in one piece. An interface device is thus provided that is particularly easy to handle and to install. The functional system created thereby is also fastened on the vehicle in a particularly stable manner. Particularly advantageously, the one-part design of the first and second contact surfaces is created by a deep-drawn part, which has the two contact surfaces set at an oblique angle toward each other. The interface device is thus formed in a particularly compact manner having obliquely angled contact surfaces situated in a particularly stable manner with respect to each other.

Alternatively, according to an example embodiment of the present invention, the first contact surface and the second contact surface are advantageously designed in two parts with respect to each other. Thus, it is possible to form the two contact surfaces initially independently of each other on components designed separately from each other, which are adapted to the respective installation situation. Preferably, one component is a conventional interface plate, which has on its two planar sides two contact surfaces that are in parallel to each other. Another component is then preferably an adapter element, which adapts to the interface plate and for this purpose has a contact surface obliquely angled with respect to the interface plate. To save costs, conventional interface plates may thus be used, which are advantageously combined with the adapter element designed in such an angled manner. Particularly preferably, the first contact surface brought into contact with the functional system is provided by the interface plate and the second contact surface is provided by the adapter element. The adapter element is then to be positioned between the interface plate and the vehicle.

Furthermore, according to an example embodiment of the present invention, at least two stay bolts are provided on the second contact surface, which are used to fasten the interface device on the vehicle. The at least two stay bolts have a longitudinal direction extending preferably crosswise or perpendicularly with respect to the second contact surface. The first contact surface facing the component is thus designed in an accordingly angled manner with respect to the at least two stay bolts. Designed in this manner, the at least two stay bolts in the installed state require a space in a passenger compartment of the vehicle, as is conventional. The at least two stay bolts are then fixed to a pedal box by lock nuts.

Advantageously, according to an example embodiment the present invention, a first through hole is provided in the first contact surface and a second through hole is provided in the second contact surface, which is concentrically situated with respect to the first through hole. In the installed state on the functional system, the pedal-travel sensor protrudes through the first and the second through hole. For particularly good force transmission, each of the through holes is situated centrally the associated contact surface.

Furthermore, in the functional system according to an example embodiment of the present invention, in particular in the hydraulic unit, an adapter is additionally provided, preferably for fastening the pedal-travel sensor, which is designed having an adapter flange contacting the component, in particular the hydraulic housing, and having an adapter mandrel radially embracing the pedal-travel sensor and penetrating through the second contact surface and the first contact surface. For this purpose, the adapter mandrel is guided in particular through the advantageous first and second through opening. Preferably, a clearance fit is respectively provided between the adapter mandrel and the first and second contact surfaces. Consequently, during assembly, it is possible to guide the interface device around the adapter mandrel in a simple manner and in particular without risk of jamming. In the assembled state, the adapter is then reliable retained on the functional system on the adapter flange via the first contact surface.

Exemplary embodiments of the approach according to the present invention are explained in greater detail below with reference to the figures.

### BRIEF DESCRIPTION OF THE DRAWINGS

5 FIG. 1 shows a perspective view of a hydraulic unit as functional system according to the related art having a hydraulic housing as component, a pedal-travel sensor and an interface plate.

FIG. 2 shows a section of the view II according to FIG. 1.

FIG. 3 shows a section of the view III according to FIG. 1 in which the interface plate is not installed.

FIG. 4 shows a section of the view III according to FIG. 1 in which the interface plate is installed.

FIG. 5 shows a perspective view of a first exemplary embodiment of an interface device according to the present invention.

FIG. 6 shows a lateral view of the first exemplary embodiment according to FIG. 5 in the state installed on the component,

FIG. 7 shows a lateral view of a second exemplary embodiment of an interface device according to the present invention in the state installed on the component,

FIG. 8 shows a lateral view of a first type of a hydraulic unit as functional system according to the related art.

FIG. 9 shows a lateral view of a second type of a hydraulic unit as functional system according to the related art.

FIG. 10 shows the view X according to FIG. 9 in a state installed on the vehicle in comparison to a first specific embodiment of a functional system according to the present invention designed as a hydraulic unit with the first exemplary embodiment according to FIG. 5.

FIG. 11 shows the view XI according to FIG. 8 in a state installed on the vehicle.

FIG. 12 shows the view XII according to FIG. 8 in a state installed on the vehicle in comparison to a second specific embodiment of a functional system according to the present invention designed as a hydraulic unit with the second exemplary embodiment according to FIG. 7.

FIG. 13 shows a perspective view of a third exemplary embodiment of an interface device according to the present invention.

FIG. 14 shows a perspective view of a fourth exemplary embodiment of an interface device according to the present invention.

FIG. 15 shows a perspective view of a fifth exemplary embodiment of an interface device according to the present invention,

FIG. 16 shows a perspective view of a sixth exemplary embodiment of an interface device according to the present invention.

### DETAILED DESCRIPTION OF EXAMPLE EMBODIMENTS

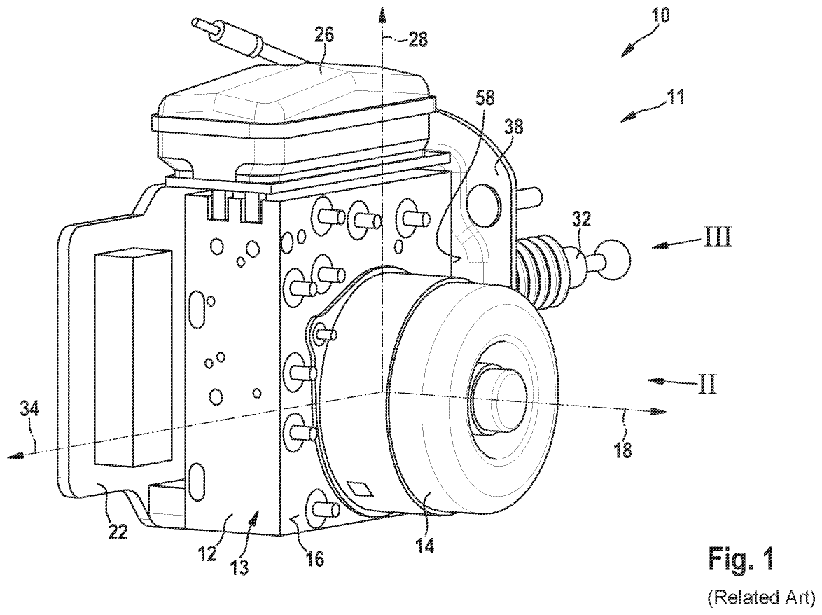

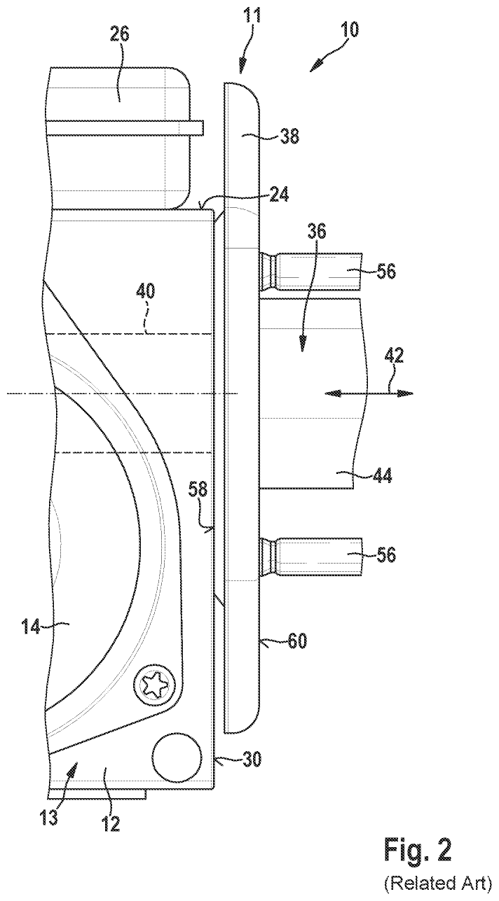

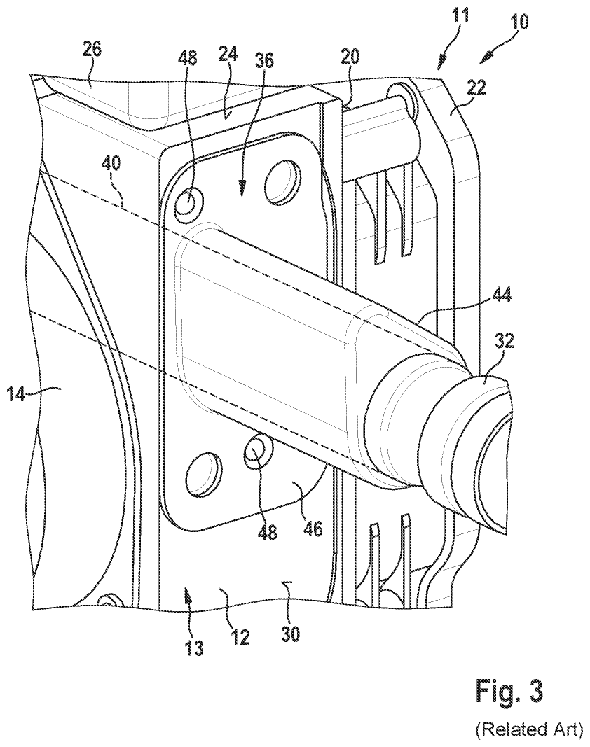

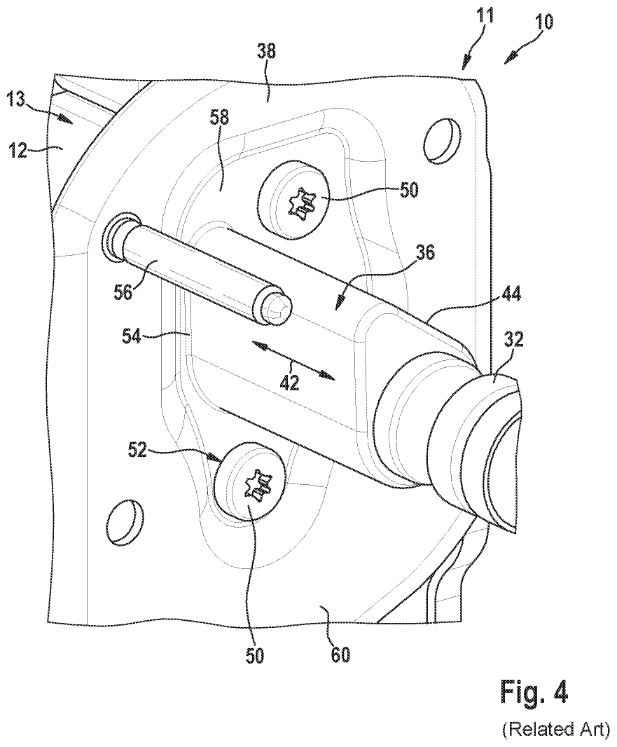

FIGS. 1 through 4 show a hydraulic unit 10 as functional system 11 of a hydraulic vehicle brake system (not shown further) having a slip control system. Such slip-control systems are antilock systems, acceleration slip regulation systems and/or vehicle dynamics control system/electronic stability programs, for which the abbreviations ALS, ASR and/or VDC/ESP are commonly used.

Hydraulic unit 10 comprises a hydraulic block or a hydraulic housing 12 as component 13, which is designed as a comparatively narrow, parallelepiped-shaped metal block made of an aluminum alloy. Component 13 or hydraulic housing 12 acts as a mechanical mount and hydraulic interconnection of hydraulic components of the slip-control system including a brake pressure control of the vehicle brake system. Such components are solenoid valves, non-return valves, hydraulic accumulators, damping chambers and pressure sensors, which are fastened in receptacles in the hydraulic housing 12. The receptacles are cylindrical depressions, blind holes and also through holes with or without stepped diameters, into which the hydraulic components are inserted and fastened in a pressure-tight manner for example by circumferential caulking. The components are recessed in the receptacles or protrude from the hydraulic housing 12. The components are not shown further here and are not provided with reference symbols. For the hydraulic interconnection, the receptacles for the components are interconnected by lines (not shown), which run through the hydraulic housing 12. The receptacles and lines form a system of bore holes of the hydraulic housing 12. The receptacles and lines may also be produced by means other than boring.

The hydraulic housing 12 is further equipped with an electric motor or motor 14, which is situated on a broad side or motor side 16 of the rectangular parallelepiped-shaped hydraulic housing 12 and which has a motor shaft (not shown), which extends into a receptacle (also not shown) of the hydraulic housing 12. The motor shaft extends with its shaft axis along or parallel to a Y axis 18 of an imaginary right-handed Cartesian coordinate system. Opposite motor side 16 there is a control unit side 20 on hydraulic housing 12, on which an electronic control unit 22 is situated. Between the control unit side 20 and the motor side 16, there is a reservoir side 24 as a narrow side of the hydraulic unit 12, on which a brake fluid reservoir 26 is situated. The brake fluid reservoir 26 projects away from hydraulic housing 12 along or parallel to a Z axis 28 of the coordinate system. Adjacent to the reservoir side 24, there is, as a further narrow side of the hydraulic housing 12, a pedal side 30, on which a pedal-travel sensor 32 projects with its pedal rod. In its longitudinal extension, pedal-travel sensor 32 extends along or parallel to an X axis 34 of the coordinate system. The pedal-travel sensor 32 is coupled to the hydraulic housing 12 in fixed and force-transmitting fashion via an adapter 36 and an interface plate 38.

An X direction is defined in this connection, which runs along or parallel to the X axis 34 and points from the axial end of pedal-travel sensor 32 in the direction of the pedal side 30. The equivalent applies to a Y direction running along or parallel to the Y axis 18 and to a Z direction running along or parallel to the Z axis 28.

Hydraulic housing 12 has a receiving borehole for a piston 40, which extends in the X direction parallel to the reservoir side 24 of hydraulic housing 12. Piston 40 belongs to a master brake cylinder (not shown) and serves to detect a braking request of a user of an associated vehicle and originally to generate brake pressure. In newer vehicle power brake systems, the master brake cylinder forms a hydraulic fallback level for a brake pressure that is normally power-generated. For this purpose, the brake pressure is normally generated by a plunger (not shown), which is controlled by the pedal-travel sensor 32.

By way of pedal-travel sensor 32, piston 40 is accessible from outside. Pedal-travel sensor 32 is attached on the pedal side 30 at the level of the receiving borehole for piston 40 with the aid of adapter 36 and interface plate 38. The pedal side 30 is the front side of hydraulic housing 12 relative to an installation situation in the vehicle. The pedal-travel sensor 32 installed there is operable by the user of the vehicle by way of a brake pedal or brake lever (not shown). A position change 42 of the pedal-travel sensor 32 occurring in the process is transmitted to piston 40 or to the plunger, depending on the interconnection configuration.

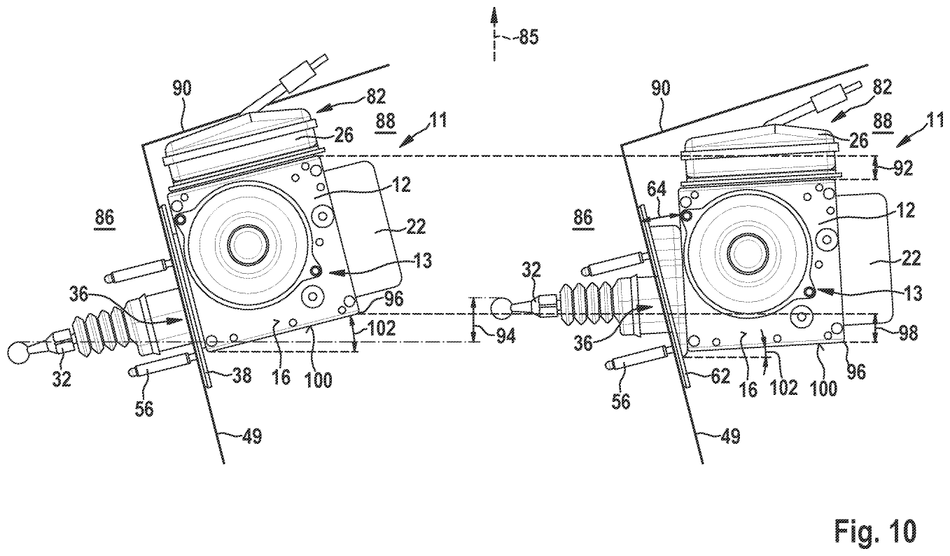

Adapter 36 is designed in hat-shaped fashion with an adapter mandrel 44 and has at its open end an essentially rectangular, plane fastening flange or adapter flange 46. By way of adapter flange 46, adapter 36 rests against pedal side 30 and is fastened there. For this purpose, the adapter flange 46 has two oppositely situated hollow pins 48, which extend into blind holes in the pedal side 30 and are retained there in clamped fashion. Adapter 36 is a deep-drawn part made of sheet metal, as a result of which the adapter flange 46 is thin. This allows for the hydraulic housing 12 and the associated components to be fastened close to for example a bulkhead 49 (FIGS. 10 through 12) of the vehicle.

After the adapter 36 is fastened on the pedal side 30, the interface plate 38 designed in the form of a perforated plate is mounted on the adapter flange 46 and is fastened by screws 50 on hydraulic housing 12. For this purpose, the interface plate 38 has two through holes 52 for passage of one screw 50 in each case and a through hole 54 for passage of the adapter mandrel 44. The contour of through hole 54 essentially follows the cross-sectional shape of the adapter mandrel 44 with a clearance fit. Two stay bolts protrude from the interface plate 38 for fastening on the associated vehicle.

The interface plate 38 has a first contact surface 58 facing and positioned on hydraulic housing 12 and a second contact surface 60 opposite the first contact surface 58 in the X direction. The second contact surface 60 is used for positioning and fastening on the vehicle, for example on the bulkhead 49 of the vehicle. For this purpose, second contact surface 60 is designed to run parallel with respect to the first contact surface 58.

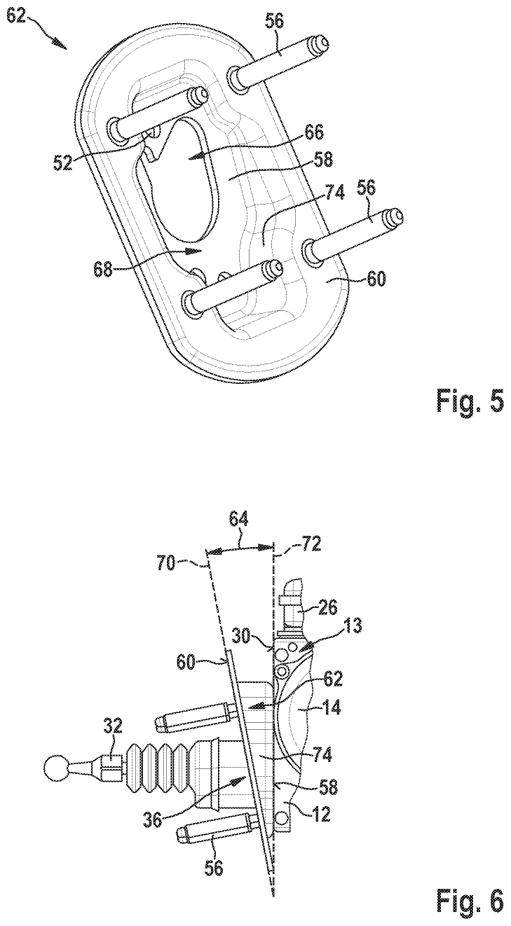

FIGS. 5 and 6 show an exemplary embodiment of an interface device 62, in which, in contrast to interface plate 38, the second contact surface 60 is set at an oblique angle 64 with respect to the first contact surface 58. In this instance, the first contact surface 58 is used for positioning the interface device 62 on the pedal side 30 of hydraulic housing 12 and the second contact surface 60 is used for positioning the interface device 62 on the bulkhead 49 of the vehicle shown in greatly simplified fashion in FIG. 10.

Interface device 62 has two through holes 52 in the first contact surface 58 for passage of one screw 50 in each case. For passage of the adapter mandrel 44, a first through hole 66 is provided in first contact surface 58 and a second through hole 68 is provided in the second contact surface 60. The first through hole 66 in the first contact surface 58 is situated relatively centrally and in its contour follows essentially the cross-sectional shape of the adapter mandrel 44. The second through hole 68 in second contact surface 60 is situated concentrically with respect to the first through hole 66 and is designed having a considerably greater cross section than the first through hole 66. Adjacent to the second through hole 68, four stay bolts 56 are screwed in on the second contact surface 60 at a distance from one another. Each of the four stay bolts 56 projects in its longitudinal extension at a right angle from a second contact plane 70 formed by second contact surface 60. Accordingly, in its longitudinal extension, each of the four stay bolts 56 is angled obliquely with respect to a first contact plane 72 formed by the first contact surface 58 by an angular amount reduced by the angle 64 from an original 90° angle. In the present case, angle 64 is 11° and in other exemplary embodiments may have a value adapted to the respective installation situation on the vehicle.

Furthermore, in the exemplary embodiment, the interface device 62 is designed in the form of a plate as a single deep-drawn part made of metal. For this purpose, the first contact surface 58 and the second contact surface 60 were each formed as a plate in a deep-drawing process, which are developed together as one piece by way of a material web 74 formed in the shape of a wedge when viewed laterally according to FIG. 6. The material web 74 represents a transverse surface.

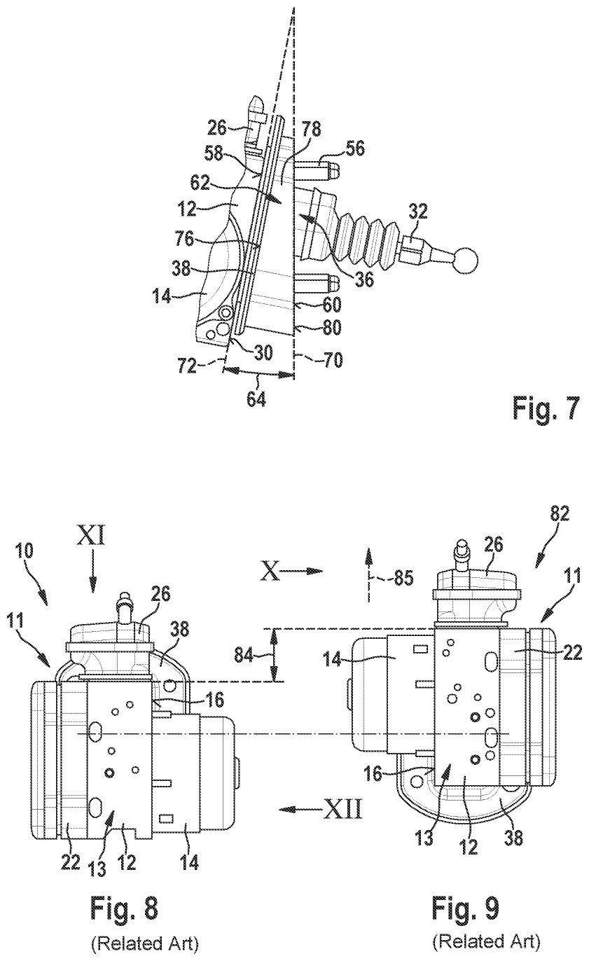

FIG. 7 shows an exemplary embodiment of the interface device 62, in which the first contact surface 58 and the second contact surface 60 are designed in two parts with respect to each other. The first contact surface 58 is configured with a conventional interface plate 38, which is to be situated or is situated on the hydraulic housing 12. Opposite the hydraulic housing 12 in the X direction, an angled adapter element 78 is situated on the interface plate 38 with a third contact surface 76. The adapter element 78 forms the second contact surface 60 with its side 80 facing away from the hydraulic housing 12. The angle 64 is enclosed between the second contact surface 60 and the third contact surface 76 of the adapter element 78, and likewise between the second contact surface 60 of the adapter element 78 and the first contact surface 58 of the interface plate 38.

In an alternative specific embodiment (not shown), the interface device 62 is designed in two parts in such a way that the second contact surface 60 to be positioned on the vehicle is formed by the interface plate 38. The angled adapter element 78 is then to be situated or is situated between the interface plate 38 and the hydraulic housing 12, the adapter element 78 resting with its third contact surface 76 on interface plate 38 and resting with its first contact surface 58 opposite the third contact surface 76 on hydraulic housing 12.

In a further alternative specific embodiment (not shown), the interface device 62 is designed so that the angle 64 enclosed between the two contact surfaces 58 and 60 is designed to be adjustable. It is thus possible to adapt the angle 64 to the respective installation situation during installation.

FIG. 8 and FIG. 9 show as functional system 11 two different types of hydraulic units 10 and 82, each having an interface plate 38.

The type shown in FIG. 8 is a so-called regular hydraulic unit 10, in which the pedal-travel sensor 32 and the piston 40 coupled to it are situated in the, with respect to FIG. 8, upper half of hydraulic housing 12. This arrangement is indicated in FIG. 8 by a dot-dash line. Accordingly, the motor 14 is positioned at the lower region of the motor side 16.

The type shown in FIG. 9 is a so-called inverse hydraulic unit 82. The pedal-travel sensor 32 and the piston 40 coupled to it are here situated in the, with respect to FIG. 9, lower half of hydraulic housing 12, which again is indicated in FIG. 9 by a dot-dash line. Accordingly, the motor 14 is positioned at the upper region of the motor side 16. Designed in this way, the inverse hydraulic unit 82 according to FIG. 9 requires more height 84 in an installation situation on the vehicle and thus more space in the vertical direction 85 than the regular hydraulic unit 10 according to FIG. 8.

In FIG. 10, the inverse hydraulic unit 82 is shown in a top view onto the motor side 16. In the case of the hydraulic unit 82 shown on the left in FIG. 10, the plane interface plate 38 is situated on hydraulic housing 12. By comparison, in the case of the inverse hydraulic unit 82 shown on the right, the angularly designed interface device 62 is situated on the hydraulic housing 12. The interface device 62 and the interface plate 38 for their part are respectively drawn as fastened on the bulkhead 49 of the vehicle. The pedal-travel sensor 32 extends in each case through bulkhead 49 into a passenger compartment 86 of the vehicle, while the hydraulic unit 82 is in each case located in an engine compartment 88 of the vehicle. The engine compartment 88 is bounded laterally by the bulkhead 49 and upwardly by a highly schematic wiper panel 90 of a hood of the vehicle that is not shown in further detail. The bulkhead 49 is designed to run obliquely from top to bottom in the direction of the engine compartment 88.

The illustrated installation situations on the vehicle show the advantage of the angled interface device 62 compared to the interface plate 38. An installation of the inverse hydraulic unit 82 using the interface plate 38 on the illustrated oblique bulkhead 49 would result in a conflict of the brake fluid reservoir 26 with the wiper panel 90. In contrast with a fastening situation by way of interface plate 38, following installation on the vehicle, the hydraulic unit 82 is situated by way of the interface device 62 so as to be rotated about its Y axis 18 by the angle 64 in the clockwise direction (with respect to FIG. 10). This results in a gain in height 92 in the vertical direction 85, which makes more space available for the brake fluid reservoir 26 in the engine compartment 88, in particular at the wiper panel.

By the rotation of the hydraulic unit 82 about its Y axis 18 achieved by the interface device 62, the pedal-travel sensor 32 is situated rotated accordingly in its longitudinal extension. In comparison to a fastening situation using interface plate 38, this has the result that an end of the pedal-travel sensor 32 in the passenger compartment 86 is raised by a height 94. The pedal-travel sensor 32 is thus more accessible in the passenger compartment 86.

In addition, after the rotation, an edge 96 of the hydraulic housing 12 opposite the reservoir side 24 and the pedal side 30 is situated lowered in the vertical direction 85 by a height 98. The amount of the height 98 is greater than the amount of the height 92. Between a bottom side 100 of the hydraulic housing 12 resting on the edge 96 and a horizontal, there is at an angle of inclination 102. So that a necessary angle of inclination 102 of 2° is always maintained, the angle 64 is chosen accordingly.

In the present specific embodiment, the angle 64 amounts to 13°. The angle 64 is to be adapted depending on the installation situation on the vehicle and the required space for the brake fluid reservoir 26. Such an adaptation is achieved by a corresponding design of multiple interface devices 62 with different respective angles 64 or by an interface device 62 that has an adjustable angle 64.

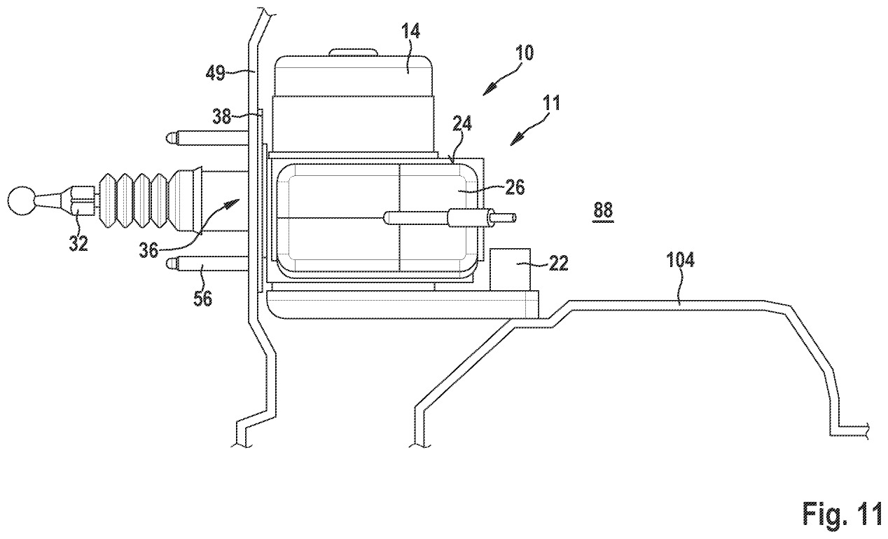

FIG. 11 shows the regular hydraulic unit 10 in a top view onto the reservoir side 24 in an indicated installed state with the plane interface plate 38 on the bulkhead 49 of the vehicle. The bulkhead 49 is here designed running straight downward into the drawing plane or at a right angle with respect to the drawing plane. In such an installation situation, there is the risk that the control unit 22 collides with a suspension housing 104 in the engine compartment 88.

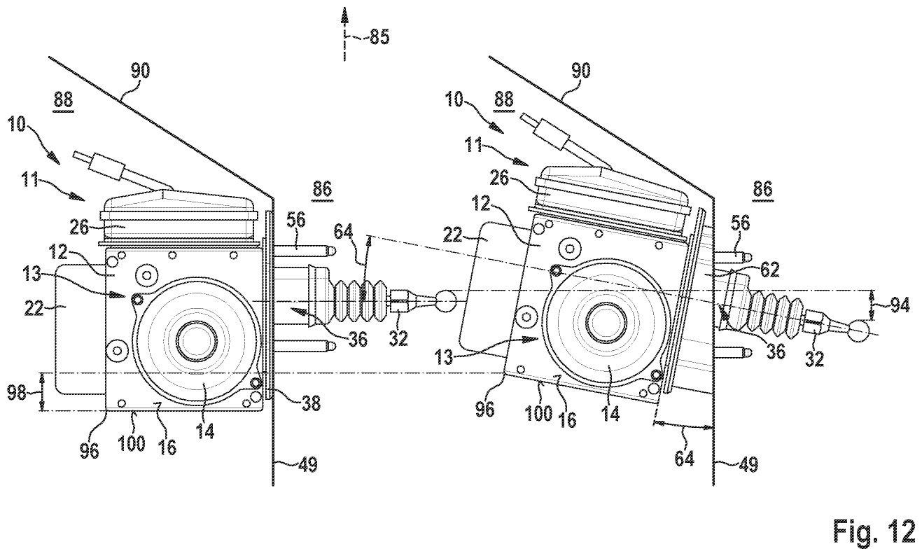

In FIG. 12, the regular hydraulic unit 10 is shown in a top view onto the motor side 16. Here, in the case of the hydraulic unit 10 shown on the left in FIG. 12, the plane interface plate 38 is fastened on hydraulic housing 12. By comparison, in the case of the hydraulic unit 10 shown on the right, the angular interface device 62 is situated on the hydraulic housing 12. The interface device 62 and the interface plate 38 for their part are respectively fastened on the bulkhead 49 of the vehicle. In this specific embodiment, the bulkhead 49 is oriented straight downward or running along the vertical direction 85. With the aid of the angled interface device 62, the hydraulic unit 10 is situated so that it is rotated about its Y axis 18 by the angle 64 in the clockwise direction (with respect to FIG. 12). For this specific embodiment, there is thus a greater requirement of space in the vertical direction 85, which is of comparatively little relevance in the case of the regular hydraulic unit 10. The decisive point is that the rotated or angled arrangement in this case provides more free space at the hydraulic housing 12 for venting. This considerably improves the ability to vent the brake system, which is necessary particularly in reconditioning.

In a further specific embodiment (not shown), the functional system 11 is a brake booster and its associated housing is the components 13, to which the interface device 62 is accordingly attached.

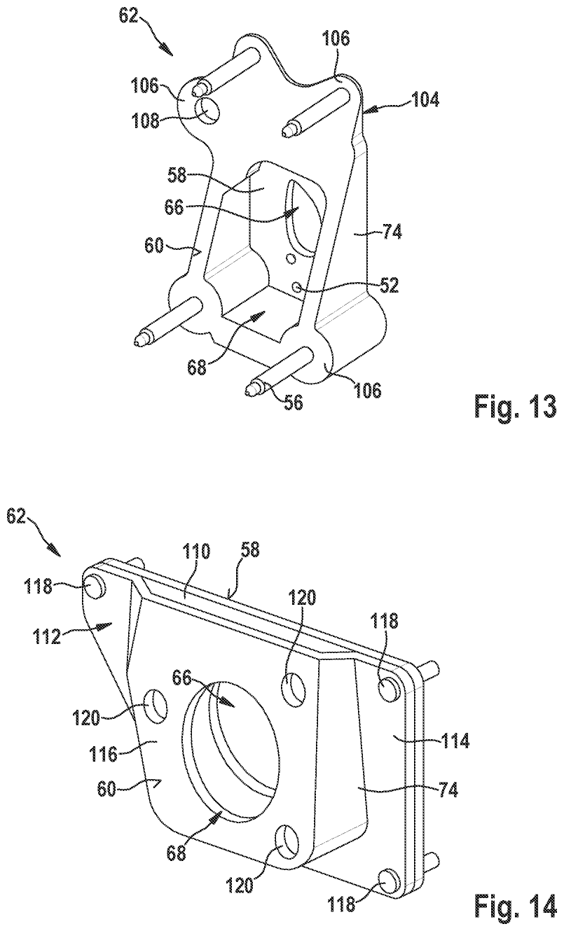

FIGS. 13 to 16 show various further exemplary embodiments of the interface device 62.

According to FIG. 13, both contact surfaces 58 and 60 are designed together in one piece as a deep-drawn part. The deep-drawn part has a radial outer contour 104, which is configured having five bulges 106. In four of the five bulges 106, a stay bolt 56 is respectively provided projecting on the second contact surface 60 for fastening on the bulkhead 49 of the vehicle. In addition, a through hole is situated in the fifth bulge 106, through which the interface device 62 is additionally to be fastened using a screw (not shown).

According to FIG. 14, the two contact surfaces 58 and 60 are designed in two parts with respect to each other. The first contact surface 58 is here configured by a plane plate 110, on which a second, angled plate 112 is positioned with a plane edge area 114 and an obliquely angled central area 116. Plate 112 is positioned with its plane edge area 114 on plate 110 in a planar manner and is fastened there by screws 118. The obliquely angled central area 116 forms the second contact surface 60, which has three through holes 120 for fastening to bulkhead 49.

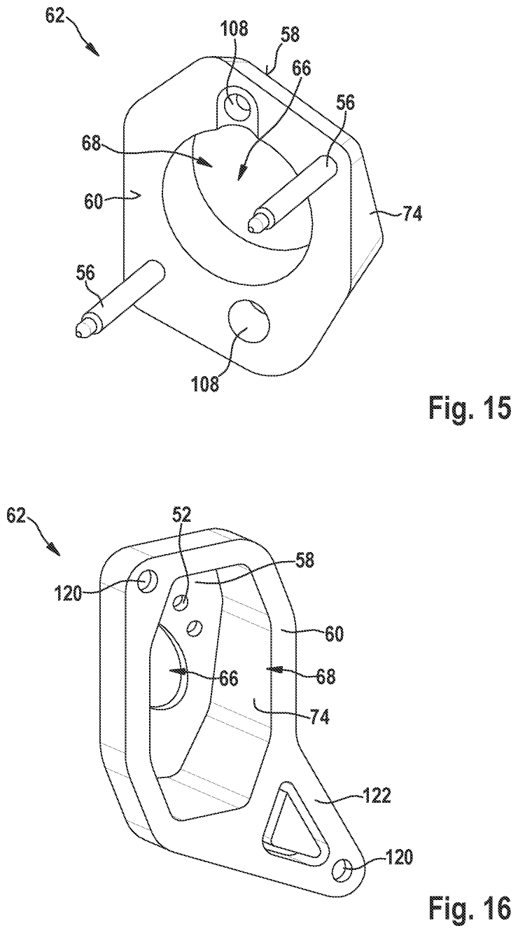

FIG. 15 shows an interface device 62 compactly designed in one piece. In this instance, the two contact surfaces 58 and 60 are on two opposite sides of a compact block, in the middle of which the two through holes 66 and 68 are located as one single through hole for allowing the adapter mandrel 44 to pass through. Two radially opposite through holes 108 are situated at its edge area for additional fastening. Radially in between, two radially opposite stay bolts 56 are provided on the second contact surface 60.

FIG. 16 shows an interface device 62 formed in one piece as a deep-drawn part, having two through holes 120 and an enlarged contact area 122 in and on the second contact surface 60.

What is claimed is:

1. An interface device for a component of a functional system of a vehicle brake system for fastening a pedal-travel sensor coupled to the component and for fastening the component on an associated vehicle, the interface device has a first contact surface to be positioned on the component and has a second contact surface to be positioned on the vehicle, the second contact surface is set at an oblique angle with respect to the first contact surface.

2. The interface device as recited in claim 1, wherein the second contact surface is set obliquely with respect to the first contact surface at an angle of 1° to 44°.

3. The interface as recited in claim 1, wherein the second contact surface is set obliquely with respect to the first contact surface at an angle of 5° to 30°.

4. The interface as recited in claim 1, wherein the second contact surface is set obliquely with respect to the first contact surface at an angle of 8° to 25°.

5. The interface device as recited in claim 1, wherein the second contact surface is set at the oblique angle with respect to the first contact surface, the angle being changeable.

6. The interface device as recited in claim 1, wherein the first contact surface and/or the second contact surface is configured in a plate-shaped manner.

7. The interface device as recited in claim 1, wherein the first contact surface and/or the second contact surface is a deep-drawn part.

8. The interface device as recited in claim 1, wherein the first contact surface and the second contact surface are together in one piece.

9. The interface device as recited in claim 1, wherein the first contact surface and the second contact surface are two pieces with respect to each other.

10. The interface device as recited in claim 1, wherein at least two stay bolts are situated on the second contact surface.

11. The interface device as recited in claim 1, wherein a first through hole is provided in the first contact surface and a second through hole is provided in the second contact surface, which is concentrically situated with respect to the first through hole.

12. A functional system of a vehicle brake system, comprising:
a component;
a pedal-travel sensor coupled to the component; and
an interface device configured to fasten the pedal-travel sensor on the component and to fasten the component on an associated vehicle, the interface device having a first contact surface positioned on the component and having a second contact surface to be positioned on the vehicle, wherein the second contact surface is set at an oblique angle with respect to the first contact surface.
